(19) United States
(12) Patent Application Publication
(10) Pub. No.: US 2013/0275903 A1
(43) Pub. Date: Oct. 17, 2013

(54) Method and Device to Design, Store and Analyze Patterns of Three Dimensional Structural Elements at the Atomic, Nanoscale, Microscale and Larger Scale Levels

(71) Applicant: Christine Marie Kennefick, Reston, VA (US)

(72) Inventor: Christine Marie Kennefick, Reston, VA (US)

(21) Appl. No.: 13/445,948

(22) Filed: Apr. 13, 2012

(51) Int. Cl. G06T 17/00; G06F 3/048

(52) U.S. Cl. 715/771; 345/420

(57) ABSTRACT

With the invention, a user is able to input the size, shape, orientation, spacing and bundling of three dimensional structural elements to create a custom-designed material texture. The method computes and stores direction cosines for vectors normal to faces, coordinates of vertices, and coordinates of the center of mass of each face for each structural element. The method orders by distance other structural elements that could interact with a particular structural element within a specified radius. A probe point may advance through the texture in a straight line a number of times specified by the user. The user may also specify the density of sampling points and radius of a sphere within which analysis is performed. Each time the sampling point advances, the method detects which vertex and which face on a structural element the point of analysis is nearest.

### TECHNICAL FIELD

The field of the invention is computer aided design of material microstructures, patterns and textures for micromechanics, elasticity, crack growth, material physics, wave collection, signal processing and electrical conduction.

### BACKGROUND ART

There are many methods of computer aided design that help generate and graphically display a three dimensional object. A three dimensional object can be graphically created, for example, by storing and linking the coordinates and parameters of many objects that comprise the topology of the object (Ravnikar, Edvard Edo and Soper, Roman, U.S. Pat. No. 8,117,011).

Computer aided design has also been developed to build nanoscale molecular devices. One such invention uses a nanomanipulator to move and position three dimensional articles until the designed device or circuit is graphically displayed (Antoniou, Nicholas, U.S. patent application Ser. No. 12/799,352 and Publication US 2010/0314353). An object can be generated by increasing or decreasing the mass or volume of an existing object, or by placing two more nanoscale objects together. Still another invention uses charge density and molecular dynamics in a computer method connected with a material assembly chamber (McCarthy, Robert J., U.S. patent application Ser. No. 10/248,092 and Publication US 2003/0139907).

The invention in the present application differs from those cited above in that the user is given a choice of working at the atomic scale, the nanoscale or the microscale. Objects specifically within a monolithic material microscopic texture are then generated by asking the user which symmetry each object will have, and then by collecting data from the user regarding dimensions, and in the case of more irregularly shaped entities, the internal angles the user desires for each entity.

The present invention places structural elements adjacent to one another along a straight line if the user inputs that such bundling is desired. The computer program performs steps to determine which faces on a single element share a common vertex. The goal of these steps is to determine which vertex and face are nearest to a point of analysis. This method of placing structural elements representing actual atoms, grains and particles is in contrast with a method of grouping nodes to determine edge elements in a finite element computer method (Imai, Kanako, U.S. Pat. No. 8,032,339).

Yet one more previous invention provides a computer aided design tool to model varying material properties in and around a single object (Shapiro, Vadim, Tsukanov, Igor G., et. al., U.S. patent application Ser. No. 10/896,407 and Publication Number 2005/0060130). The goal of the invention here, in contrast, is to provide a tool in which the atoms and particles being modeled have one set of micromechanical properties and the matrix within which the particles reside perhaps one other different set. This invention allows the user to set the number, position, symmetry and orientation of each material entity is set to model and test a custom designed microscopic texture.

### SUMMARY OF THE INVENTION

### Technical Problem

The grain shapes, phase shapes, and atomic arrangements at a structural level in material are very often not simple spheres, ellipsoids and polygons. They can any of several symmetries, or no symmetry at all. Yet these shapes and arrangements can be critical to such phenomena as superconductivity, protonic conduction, and increased ductility in lightweight ceramic materials that could reduce reliance on fossil fuels, fuel cells, batteries and steels and superalloys of high mass density.

To date, computer program tools to aid material design rely on elements, meshes, or regular polygon shapes. The elements and meshes do not facilitate intricate calculation and analysis near and at the boundary of an irregularly shaped structural feature. A computer design tool is needed that allows a user to set up a texture of new structural features and then rapidly perform calculations of elastic stress and electrical conduction without meshes and finite elements.

### Solution to the Problem

This invention, as a solution, is a computer program that produces and tests monolithic material structural patterns that can be fabricated in an industrial setting in a relatively simple manner. The user can specify with each run of the program the angular shape, size, spacing and orientation of each structural element. These custom structural shapes can represent distortions of atomic groups, irregularly shaped grains, or shapes of entire phases in a material. These optimized elements are necessary to fabricate a new material in a monolithic form. The term monolithic here refers to the absence of deposited layers, interconnects, dots, lines and devices. Functionality is completely controlled within the atomic arrangements, grains and phases of the material.

### Advantageous Effects of the Invention

A central advantage of the invention is that it runs rapidly on a notebook computer and produces models of three dimensional material textures that can be fabricated in monolithic form. The user can custom design three dimensional grain and particle shapes with planar sides and with any of several symmetries. The shapes have faces that meet together at angles that the user specifies and are not spheres or ellipsoids. An optimized texture from the computer program will readily have information such as size, shape, orientation and volume fraction of particles, grains and phases. Such information is necessary for a facility to fabricate a new prototype material.

The computer program also stores information that facilitates calculation of closed form solutions at a near the interface between a particle and matrix material. The program calculates and stores the coordinates of the vertices and midpoints of the faces. It also computes and stores the components of the vector normal to each face.

A third advantage of the program is that it positions a sampling point through the material texture and allows calculation and analysis at that sampling point. The grain and face nearest the sampling point is detected by program.

### BRIEF DESCRIPTION OF THE DRAWINGS

Reference will be made to the accompanying drawings, which can represent any length scale from the atomic to continuum levels. The size, shape, orientation and spacing of the elements shown are not exact but are representative of any texture that produces the elastic stress patterns and region of analysis covered in the Claims and Detailed Description.

FIG. 1 is a schematic diagram of the two and four dimensional vectors in a computer programming language that store the information described in claims 1 and 2.

FIG. 2 shows the radius of interaction with an example grain at its center and the ordering of other grains by distance from that example grain and within the radius of interaction.

FIG. 3 shows a sample point of analysis within the computer program that sequentially positions the point of analysis throughout the entire sphere in the diagram.

### DETAILED DESCRIPTION OF THE INVENTION

The invention first asks a user to input several pieces of important information at the keyboard of a computing device. The user reads the requests for input on the screen of the computing device. The reader responds by typing numbers at the keyboard of the computing device.

The invention first asks the user whether there will be bundling or no bundling of the structural elements. Bundling occurs when a each member of a group of a structural elements share a common face with the structural element next to it. A single bundle has structural elements all of the same size and symmetry. The structural elements within a single bundle all lie along a straight line that is perpendicular to the shared faces.

When bundling is desired, the user may specify whether for the entire material texture each bundle has the same number of structural elements, or whether each bundle will have a number of elements that could be different from the other bundles. The user can also specify the number of bundles in the texture. The number of bundles can be as small as one or can be any integer number larger than one. The user may also specify, within a particular length scale, whether all the bundles in a texture have the same type of structural element or whether one or more bundles will have a different structural element. A different structural element means that either the symmetry of the size of the elements in a particular bundle differ in size, symmetry, or both from that of the structural elements in another bundle.

An example of bundling supported by the invention is the design of a material texture comprised of bundles of needlelike grains. At the atomic level, bundling might be used to align several rectangular parallelopipeds face-to-face along a straight line. Each parallelopiped would have the same atomic arrangement about its center. The same bundling at the atomic level with aligned octohedra is also supported by the invention. Regardless of the type of structural element that is bundled, a single bundle is defined as an alignment of a finite number of structural elements, all of the same symmetry and size, in a straight line with each element sharing a face with each element that is adjacent to it.

The user may also choose the length scale for the material texture. The invention asks the user to input at the keyboard a number indicating whether the length scale is at the atomic, nanometer or micron length scales. Because the invention computes the results of series and closed form solutions for elastic stress, wave propagation and other physical phenomena, the invention is independent of any prescribed length scale. The user may therefore use the invention to compute, design or extend solutions to material architectures at the continuum level as well as at the microscopic level.

Information regarding the material texture as a whole as well as properties of the individual structural elements are stored in vectors and arrays in a computer programming language such as C++. The vectors are used for rapid retrieval of information in functions used for computation later in the computer program.

For example, basic information about the material texture that the is stored in a two dimensional vector. The vector has two rows. The first row contains vectors with information regarding bundled structural elements. The second row contains information regarding unbundled structural elements. The first vector in the first row contains a flag of 0 or 1. A flag of 0 indicates that the user desires unbundled structural elements. A flag of 1 indicates that the user has specified bundled structural elements.

The first row of the two dimensional vector just described contains more vectors with flag of 0 or 1. Some of these flags indicate whether or not all the bundles have the same orientation and same number of structural elements. Other stored flags of 0 or 1 indicate whether the structural elements across all the bundles have the same shape or size. Finally, other vectors store the number of bundles in the material texture, and, if each bundle has the same number of elements, the number of structural elements in each bundle. If each bundle has a different number of elements, a separate simple array structure stores the number of structural elements in each bundle.

The second row of the two dimensional vector also contains vectors that store flags of 0 or 1. These flags indicate whether or not the orientation, shape and size of unbundled structural elements in a texture are all the same. Another vectors in this second row contain an integer flag for the length scale the user desires. Still one more vector stores the total number of structural elements in the texture.

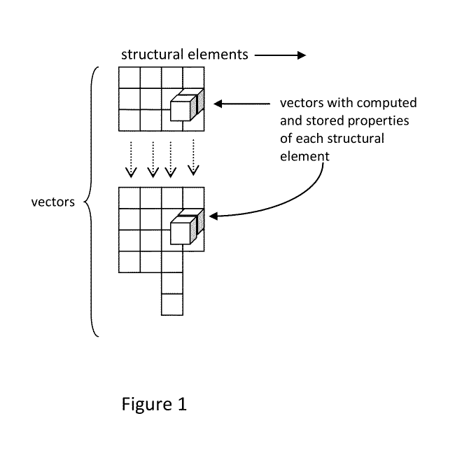

For each structural element, there are many shape parameters stored in a four dimensional vector, as depicted schematically in FIG. 1. For each structural element, the first vector in FIG. 1 contains flags indicating the shape of that particular structural element. One flag number indicates the symmetry of main shape, which includes but is not limited to monoclinic, orthorhombic, tetragonal, hexagonal, trigonal, cubic and triclinic. For some of the symmetries, there is a second flag that denotes further information about the shape of the structural element. This further information includes but is not limited to the presence of a distorted parallelopiped, presence of faces outlined by right triangles, isosceles triangles or oblique triangles, and presence of a cube or an octohedron. Yet one more flag denotes the presence or absence of pyramidal endcaps on the structural element. Still one more flag indicates whether or not the structural element is tapered.

Three orientation angles are stored in the vector depicted in FIG. 1 for each structural element. In this invention, the user may rotate each structural element or bundle about the x, y and z axes in a global Cartesian coordinate system. The first orientation angle arises from rotation about the z axis that points toward the user. The second angle arises from rotation about an x axis that points to the right. The third angle arises from a twist rotation about a y axis pointing upward. The three orientation angles are stored in both radian and degree units for simple retrieval from the vector in FIG. 1.

Length dimensions for each structural element are also stored in a vector for each structural element. Depending upon the symmetry of the structural element, the program asks the user for specific width, depth and length dimensions, as needed. If there are pyramidal endcaps on a structural element, the user may specify the height of the pyramid caps in term of a percentage of the length of the main part of the structural element. If there is tapering, the user may specify the area the smaller face has at the end of the tapering in terms of a percentage of the area of the larger face at the other end of the element. The program then computes and stores the appropriate width and depth of the smaller face. If bundling is present, the user is asked to input dimensions only once for each structural element that might have different dimensions across the bundles. The program will automatically store dimensions of like structural elements within each bundle or across all bundles, as previously specified by the user.

If any faces are outlined by oblique triangles, the user can specify the magnitude of the oblique angle in degrees. The user also inputs at the keyboard the lengths of the two shorter sides of the oblique triangle. The program computes the length of the longest side and stores the length of the two longest sides and the height of the oblique triangle.

Three interior angles in degree and radian units are stored for each element in the vector shown in FIG. 1. Interior angles of the structural elements are either assigned, computed and stored by the computer program, or entered by the user at the keyboard. Interior angles of 90 degrees associated with orthorhombic and tetragonal shapes and with a cube, for example, are assigned and stored by the computer program. Interior angles different from 90 degrees are stored with the angles become acute due to dimensions and distortions set by the user. Interior angles of triangular faces outlined by right and isosceles triangles are computed and stored by the computer program. The user may distort interior angles to less than 90 degrees, as desired, to form monoclinic and triclinic elements from a parallelopiped. These internal angles that are entered by the user at the keyboard are stored in the vector shown in FIG. 1 for that particular element.

New basis vectors, which generally do not coincide with unit vectors in the x, y and z directions of the global Cartesian coordinate system, are used by the method. The new basis vectors help compute direction cosines and coordinates associated with each structural element. The new unit vectors are perpendicular to the right face, top face and front face of a rectangular parallelopiped. They stay fixed, perpendicular to the faces of this virtual parallelopiped, as a structural element is rotated and distorted in space to its final symmetry and orientation. As the user rotates a particular structural element in space, the virtual parallelopiped is oriented in space in the same manner with the same orientation angles. The direction cosines of the new basis vectors with respect to the global x, y and z axes are then computed and stored by the computer method in a vector for each structural element, as shown in FIG. 1.

Using the new basis vectors described in the last paragraph, the method computes the direction cosines between the global x, y and z axes and the vector normal to each face of a structural element. The direction cosines are stored in a vector for each structural element, as shown in FIG. 1.

The coordinates of the vertices and face midpoints are also computed and stored in a vector for each structural element, as depicted in FIG. 1. The coordinates are relative to the center of mass of a cross section of the structural element midway between the top and bottom of the main part of each element. The main part of each structural element is defined here as the only section or middle section of the element that excludes any pyramidal endcaps.

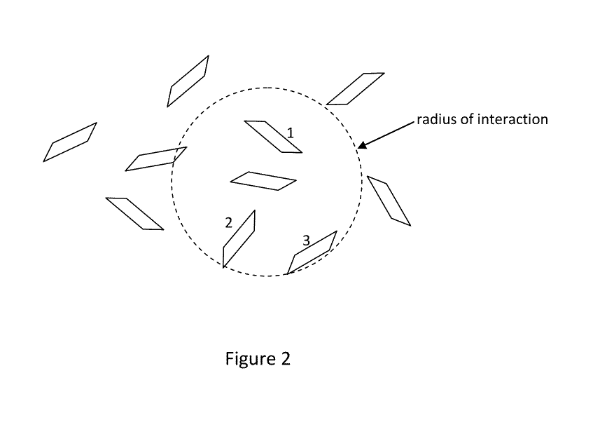

At the keyboard, the user designates a main structural element in the texture. The user is then able to enter the coordinates of each unbundled structural element or each bundle relative to this main structural element. In this manner, the user is able to custom design a material texture, shown schematically in FIG. 2.

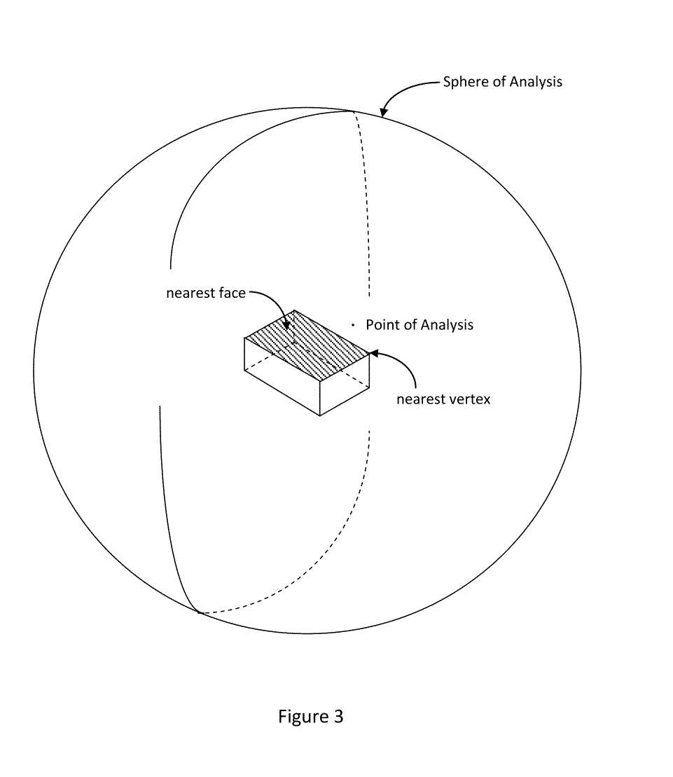

The user also specifies the initial position of a probe point relative to the main structural element. The probe point is the center of the sphere in FIG. 3 within which data is computed for the material texture within a single loop of the computer program.

The computer method in this invention computes and then stores in vectors in FIG. 1 information such as the location of each structural element with respect to the probe point and also with respect to every other structural element in the texture. When there is bundling, program also computes and stores the location of the center of each bundle with respect to the probe point, the location of each structural element with respect to the center of the bundle in which it resides, and the coordinates of the center of every other bundle with respect to the center of a particular bundle.

The user may also specify a radius of interaction around each structural element, as shown in FIG. 2. The radius of interaction is a radius of a virtual sphere that has its center around each structural element. Structural elements whose centers are located within the sphere around a particular structural element can interact with the structural element at the center of the sphere.

The type of interaction is set by the user by formulae for computation that placed into the program by the user. For each element in the texture, the computer program identifies the interacting structural elements. The coordinates of the interacting elements with respect to a particular structural element are stored in a vector as shown in FIG. 1. The coordinates are stored in order 1, 2, 3 . . . of distance from the nearest to the farthest interacting element, as shown in FIG. 2. For each structural element, the beginning and ending indices of the vectors of containing the coordinates of the interacting elements are stored in the Index Record described in the next paragraph.

The Index Record is one more four dimensional vector in a computer programming language in the invention. For rapid retrieval of information, the Index Record stores key indices of vectors for each structural element in FIG. 1. The many shapes of the structural elements have different numbers of faces and vertices. In addition, the number of bundles and elements in a material texture can differ from one texture design to the next. Finally, the number of interacting structural elements for can differ from element to element. A record is kept denoting where information begins and ends for faces, vertices, bundles and interacting particles.

Each structural element has a set of vectors in the Index Record. For each of these vectors, the first index denotes the bundle number of the structural element. If the structural elements are unbundled, this first index a 0.

The second index integer of the vector in the Index Record contains the structural element number that identifies that structural element within its bundle or, in the case of unbundled structural elements, within the material texture as a whole. The third index is an integer 0, 1, 2, 3, . . . denoting the type of information stored in the set of vectors in FIG. 1. A 0 for the third index denotes direction cosines of vectors normal to the faces, for example, and a 1 denotes coordinates of vertices.

The fourth index is a 0 or a 1 in each vector in the Index Record. The vector with a third index of 0 and fourth index of 0, for example would contain the index in FIG. 1 of where the direction cosines for the face normals begin. A fourth index of one for the same vector would contain the index in FIG. 1 of where the direction cosines for the face normals end. These pairs of vectors indexed by the 0 or 1 in the fourth position usually contain indices for where information begins and ends in FIG. 1. Sometimes the pairs of vectors contain the same single index location in FIG. 1. An example for the same single index is the location index for the single vector in FIG. 1 that simply stores the coordinates of the structural element with respect to the probe point.

The user can specify the initial position of probe point in the material texture. The probe point can physically represent a position in a wave, a crack tip, or any other central position in an entity that the user desires. During a single loop of the computer method, sampling and analysis is performed at points within the virtual sphere around the probe point, as shown in FIG. 3. The user can specify the starting and end points and the number of positions along a straight line that the user would like the probe to jump. After the probe jumps to the new position, analysis is again performed within the sphere in FIG. 3 centered on the probe point. The user may thus perform analysis in a few or several regions of a material texture without setting up the material texture and running the computer program again.

The radius of the sphere of analysis shown in FIG. 3 can be specified at the beginning of each run of the computer program. Within this sphere, a virtual point where sampling, computation and analysis is done moves radially and angularly until the interior of the entire sphere is covered. An adjustment inside the computer program can be made by the user to perform analysis in only a part of the interior of the sphere. The number of positions of the sampling point in FIG. 3 along the radius of the sphere is specified by the user at the keyboard near the beginning of the program. Thus the density of sampling points can be adjusted for rapid or detailed analysis.

The “point of analysis” or “sampling point” is shown in FIG. 3 near a structural element. This point is the same virtual point that moves radially and angularly inside the sphere in FIG. 3 and discussed in the last paragraph. Using the stored coordinates of vertices of each structural element, the program detects which structural element and which vertex of that structural element is nearest the point of analysis. Stored inside the vectors for each structural element in FIG. 1 are the vector indices of the faces that surround each vertex and the vector indices of the vertices that surround each face. Once the program identifies which vertex is nearest the point of analysis, it determines which face surrounding that vertex has its center of mass nearest the sampling point. The user may therefore modify the program to set up limits of integration across the face nearest the point of analysis, with the program itself detecting the face nearest the sampling point during a run of the program.

### INDUSTRIAL APPLICABILITY

The invention can potentially decrease the time and cost needed to design and implement new sources of energy, sensing, actuation, and structural integrity in material microstructures.

The invention allows a user to custom design and test patterns of structural elements. These structural elements, with any of several symmetries at the nanoscale to micron scale, can represent real particles, grains and phases whose size, shape and orientation must be specified for fabrication of a prototype material.

Forces representing waves and closed form formulae for elastic stresses can also be added to the computer program by the user to evaluate the response of a particular structural texture. When the forces arise from the wavelike properties of electrons or hydrogen ions, a user can optimize superconduction or protonic conduction, for example, through the redistribution of strain energy.

A few optimized material textures would save a company enormous amounts of time and money in repetitive fabrication and testing. Modeling and testing could be done rapidly many times by computer for significant forms of electrical conduction without the use of fossil fuel power or battery power for input.

Forces from electromagnetic waves, wind waves, or mechanical loads can be added by the user to the point of analysis. Rapid evaluation of material response around intricately shaped structural elements could then lead to design of new sensors, actuators and materials subjected to sudden loads.

### CITATIONS

| | Patent Application/ | |
|---|---|---|
| Patent Number | Publication Number | Inventor(s) |
| 8,117,011 | | Ravnikar, Edvard Edo |
| | | and \check{S}oper, Roman |
| 8,032,339 | | Imai, Kanako |
| | 12/799,352 | Antoniou, Nicholas |
| | 2010/0314353 | |
| | 10/896,407 | Shapiro, Vadim, Tsukanov, |
| | 2005/0060130 | Igor G., et. al. |
| | 10/248,092 | McCarthy, Robert J. |
| | 2003/0139907 | |

What is claimed:

1. A sequence of steps in a computer programming language in which information regarding the number, shape, size, orientation, bundled or unbundled nature, number of tests, and radius of interaction of three dimensional grains or atomic geometrical units is requested for input by the user and stored in vector structures in a computer programming language.

2. A sequence of steps in which information regarding components of vectors to grain faces, coordinates of the center of mass of the faces, coordinates of vertices, distances of grains to one another, and ordering of grains by distance to one another are determined, computed and stored in a vector structure in a computer programming language for each grain or geometrical unit.

3. A sequence of steps in which a sampling point, which can represent a crack tip or point of analysis within a wave or within a mathematical computation, is advanced forward in sequential steps in a computer program routine and its position is determined by first finding the nearest vertex within a set of grains, and then by determining the nearest center of mass of the face that is member of the set of faces that surround that nearest vertex.
